(19) United States
(12) Patent Application Publication
(10) Pub. No.: US 2013/0148769 A1
(43) Pub. Date: Jun. 13, 2013

(54) WIRELESS APPARATUS

(71) Applicant: Shunsuke Hirano, Kanagawa (JP)

(72) Inventor: Shunsuke Hirano, Kanagawa (JP)

(73) Assignee: PANASONIC CORPORATION, Osaka (JP)

(21) Appl. No.: 13/816,156

(22) PCT Filed: Feb. 6, 2012
(86) PCT No.: PCT/JP2012/000791

§ 371 Date: Feb. 8, 2013

(30) Foreign Application Priority Data
Mar. 9, 2011 (JP) 2011051894

(51) Int. Cl. H04L 7/033

(52) U.S. Cl. CPC H04L 7/033
USPC 375/376

(57) ABSTRACT

A wireless apparatus includes a clock generation PLL circuit of a digital baseband section. A variable output regulator receives as an input a VCO control voltage for controlling an oscillation frequency of a VCO in the PLL circuit, varies an output voltage in accordance with the VCO control voltage, and supplies, as a supply voltage, the output voltage to a power terminal of a high frequency circuit, such as an amplifier. The VCO control voltage changes in accordance with temperature or process variations, and the supply voltage of the high frequency circuit is controlled in accordance with the VCO control voltage. For this reason, performance deterioration ascribable to the temperature or process variations can be compensated for.

### TECHNICAL FIELD

The invention relates to a wireless apparatus having a digital baseband section and a high frequency circuit.

### BACKGROUND ART

In a wireless apparatus, in particular, an amplifier for amplifying a high frequency signal undergoes great performance variation for reasons of variations in semiconductor manufacturing processes or temperature variations that occur during actual operation. For instance, if a decrease in an amount of electric current flowing through transistors that make up an amplifier is induced by process variations, the maximum oscillation frequency fₘₐₓ will become smaller, thereby deteriorating a frequency characteristic. Moreover, a temperature increase also induces a longer operation delay on the transistors, so that the frequency characteristic is deteriorated.

A supply voltage regulator for regulating a supply voltage of circuitry has been proposed to solve the problem of performance deterioration attributable to the process variations or temperature variations (see Patent Literature 1).

FIG. 15 is a diagram showing a configuration of an example of an existing supply voltage regulator described in connection with Patent Literature 1. An integrated circuit 20 includes a principal circuit 21, an oscillator 22, a counter 23 that counts a signal output from the oscillator to thereby determine a frequency, and a controller 24 that outputs a signal for regulating a voltage output from a power supply circuit 25 on the basis of a frequency of the output from the oscillator.

The oscillator 22 is made up of a ring oscillator. FIG. 16 is a diagram showing an example of a configuration of the ring oscillator. The ring oscillator includes an odd number of series-connected inverters 31 to 35. A signal output from the output-side inverter 35 is fed back to an input terminal of the input-side inverter 31. When a power supply is fed to the ring oscillator, the ring oscillator performs oscillation at a frequency that depends on an operation delay time of the inverters.

### CITATION LIST

### Patent Literature

Patent Literature 1: International Publication No. WO 2007-034540

### SUMMARY OF INVENTION

### Technical Problem

In the ring oscillator of the oscillator 22, the operation delay time of the inverters changes depending on process variations. For instance, when a threshold voltage Vth of transistors decrease for reasons of process variations, the operation delay time of the inverters becomes shorter, and an oscillation frequency of the ring oscillator increases. To the contrary, as the threshold voltage Vth of the transistors increase for reasons of the process variations, the operation delay time of the inverters becomes longer, and the oscillation frequency of the ring oscillator becomes lower.

The operation delay time of the inverters also changes for reasons of temperature variations. For instance, when a temperature decreases, the operation delay time of the inverters becomes shorter, and the oscillation frequency of the ring oscillator becomes higher. Conversely, when the temperature increases, the operation delay time of the inverters becomes longer, and the oscillation frequency of the ring oscillator becomes lower.

The supply voltage regulator shown in FIG. 15 observes an output frequency of the oscillator 22 by taking advantage of the foregoing characteristic of the ring oscillator, equivalently detecting process variations and temperature variations. Performance deterioration of the principal circuit is prevented by regulating the supply voltage in accordance with a detection result. When process or temperature variations, by contrast, occur in a direction in which an operation margin of the principal circuit increases, lower power consumption can be achieved by lowering the supply voltage to diminish the operation margin.

However, separately implementing on an integrated circuit an oscillator for detecting the process variations and the temperature variations adds to a chip area, which raises another problem of cost increase.

The invention has been conceived in light of the circumstance and aims at providing a wireless apparatus capable of optimizing performance even when process or temperature variations occur without addition of circuitry, such as an oscillator for detection purposes.

### Solution to Problem

According to one aspect of the present invention, there is provided a wireless apparatus comprising:

a PLL circuit that has a voltage controlled oscillator configured to oscillate a signal having a frequency commensurate with a control voltage;

a variable output regulator configured to change an output voltage in accordance with the control voltage; and

a high frequency circuit that is supplied with, as a supply voltage, the output voltage of the variable output regulator.

By means of the configuration, a control voltage of the voltage controlled oscillator changes along with temperature or process variations, and the supply voltage of the high frequency circuit can be controlled in accordance with a control voltage. Hence, performance deterioration, which would otherwise occur when the temperature or process variations occur, can be compensated for.

### Advantageous Effects of Invention

The invention enables optimization of performance even when process or temperature variations occur without addition of separate circuitry, such as an oscillator for detection purposes.

### BRIEF DESCRIPTION OF DRAWINGS

FIG. 1 is a block diagram showing a configuration of a wireless apparatus.

FIG. 2 is a circuit diagram showing an example of a configuration of an amplifier for amplifying a high frequency signal.

FIG. 3 is a graph showing a typical characteristic of a transistor.

FIG. 4 is a block diagram showing a configuration of a wireless apparatus of a first embodiment of the invention.

FIG. 5 is a diagram showing a configuration of a variable output regulator.

FIG. 6 is a graph showing an example of temperature dependence of an oscillation frequency of a ring oscillator appearing when a PLL circuit is not locked.

FIG. 7 is a graph showing an example of process variation dependence of the oscillation frequency of the ring oscillator appearing when the PLL circuit is not locked.

FIG. 8 is a graph showing an example of temperature dependence of a VCO control voltage appearing when the PLL circuit is locked.

FIG. 9 is a graph showing an example of process variation dependence of the VCO control voltage appearing when the PLL circuit is locked.

FIG. 10 is a graph showing an example of amplifier's supply voltage characteristic versus temperature variation.

FIG. 11 is a graph showing an example of amplifier's supply voltage characteristic versus process variation.

FIG. 12 is a block diagram showing a configuration of a wireless apparatus of a second embodiment of the invention.

FIG. 13 is a diagram showing a configuration of a modulator.

FIG. 14 is a block diagram showing a configuration of a wireless apparatus of a third embodiment of the invention.

FIG. 15 is a diagram showing a configuration of an example of an existing supply voltage regulator.

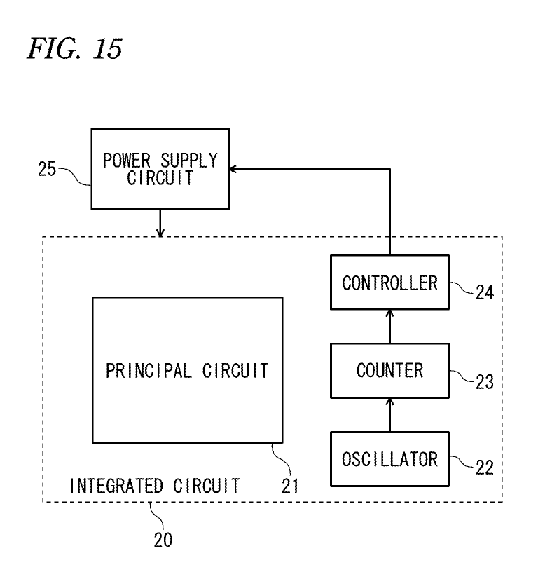

FIG. 16 is a diagram showing an example of a configuration of a ring oscillator.

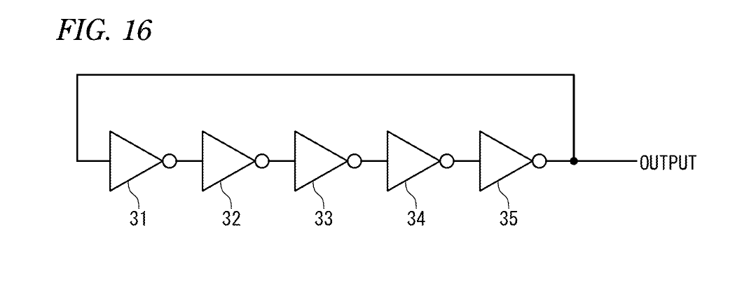

### DESCRIPTION OF EMBODIMENTS

A configuration and operation of a common wireless apparatus are now described in advance of explanations about embodiments of the invention.

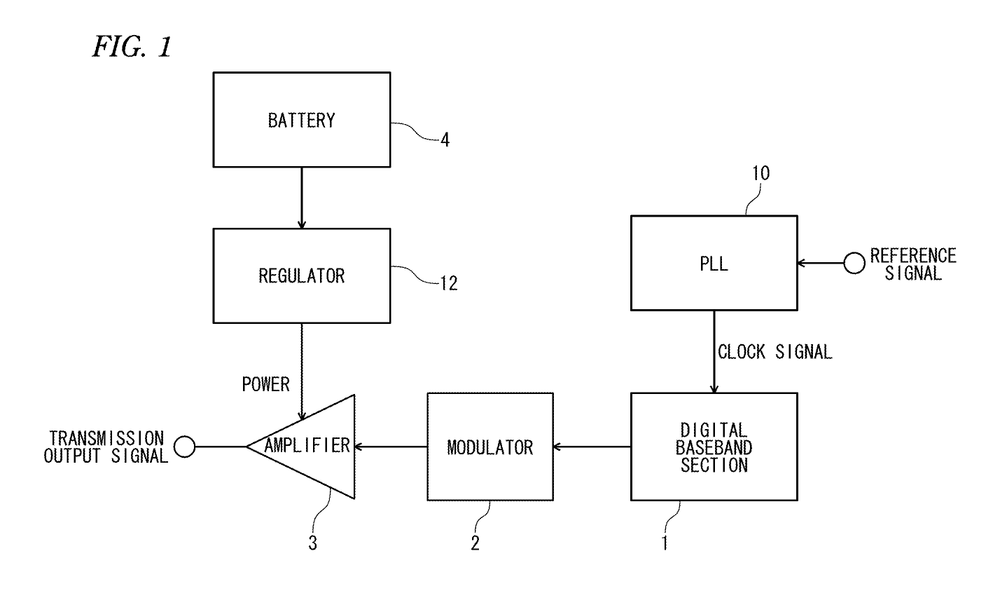

FIG. 1 is a block diagram showing a configuration of a wireless apparatus. The wireless apparatus is made up of a digital baseband section 1, a modulator 2, an amplifier 3, a battery 4, a PLL circuit 10, and a regulator 12.

The digital baseband section 1 operates in response to a clock signal that has a predetermined frequency and is output from the PLL circuit 10 and generates a transmission baseband signal from transmission data. The modulator 2 modulates the baseband signal output from the digital baseband section 1 to thereby generate a high frequency modulated signal. The amplifier 3 is an amplifier for amplifying a high frequency signal and amplifies the high frequency modulated signal output from the modulator 2, outputting a transmission output signal. The regulator 12 receives as an input a voltage output from the battery 4 and generates a predetermined voltage, supplying the voltage to a power terminal of the amplifier 3.

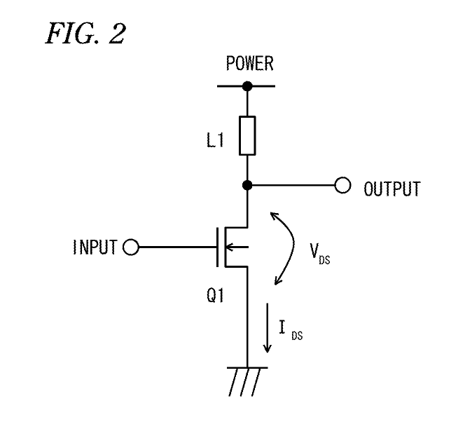

FIG. 2 is a circuit diagram showing an example of a configuration of the amplifier 3 employed for amplifying a high frequency signal. The amplifier 3 has a transistor Q1 for amplification purpose. An input signal is input to a gate terminal of the transistor Q1. A source terminal of the transistor Q1 is grounded. A drain terminal of the transistor Q1 is connected to the power supply by way of the load L1. An output signal is output from a node between the drain of the transistor Q1 and the load L1. A drain-source current of the transistor Q1 is taken as I_{DS}, and a drain-supply voltage of the transistor Q1 is taken as a V_{DS}.

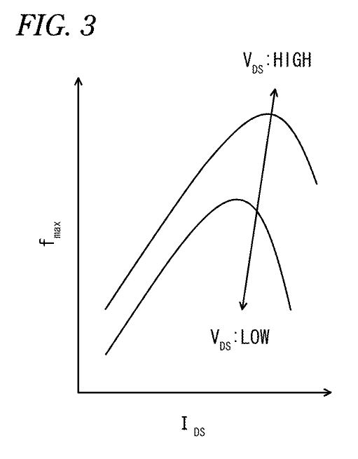

FIG. 3 is a graph showing a typical characteristic of the transistor. In FIG. 3, a vertical axis represents a maximum oscillation frequency fₘₐₓ, and a horizontal axis represents a drain-source current I_{DS}. The transistor exhibits a much superior high frequency characteristic as the maximum oscillation frequency fₘₐₓ increases. As the drain-source current I_{DS} increases, the maximum oscillation frequency fₘₐₓ increases up to a predetermined frequency. However, the maximum oscillation frequency fₘₐₓ hits the ceiling in due time. If the electric current is caused to flow excessively, the maximum oscillation frequency fₘₐₓ will drop. The transistor also has another characteristic of the maximum oscillation frequency fₘₐₓ becoming higher as the drain-supply voltage V_{DS} increases. In designing circuitry of the transistor, the drain-source current I_{DS} and the drain-supply voltage V_{DS} are determined such that a desirable maximum oscillation frequency fₘₐₓ is gained.

The amplifier 3 exhibits great performance variations for reasons of process variations in semiconductor manufacturing processes or temperature variations which occur during actual operation of the amplifier. For instance, when an electric current flowing into the transistor which makes up the amplifier decreases for reasons of process variations, the maximum oscillation frequency fₘₐₓ decreases, thereby deteriorating a frequency characteristic. Further, when a temperature increase occurs, operation delay of the transistor increases, thereby deteriorating the frequency characteristic. Since an increase in the supply voltage of the amplifier leads to an increase in the drain-supply voltage V_{DS}, performance of the transistor can be enhanced.

In order to solve a problem of performance deterioration of circuitry of a wireless apparatus, such as an amplifier, due to process variations or temperature variations, the embodiment adopts a configuration that supplies a supply voltage to target circuitry while changing the same.

### First Embodiment

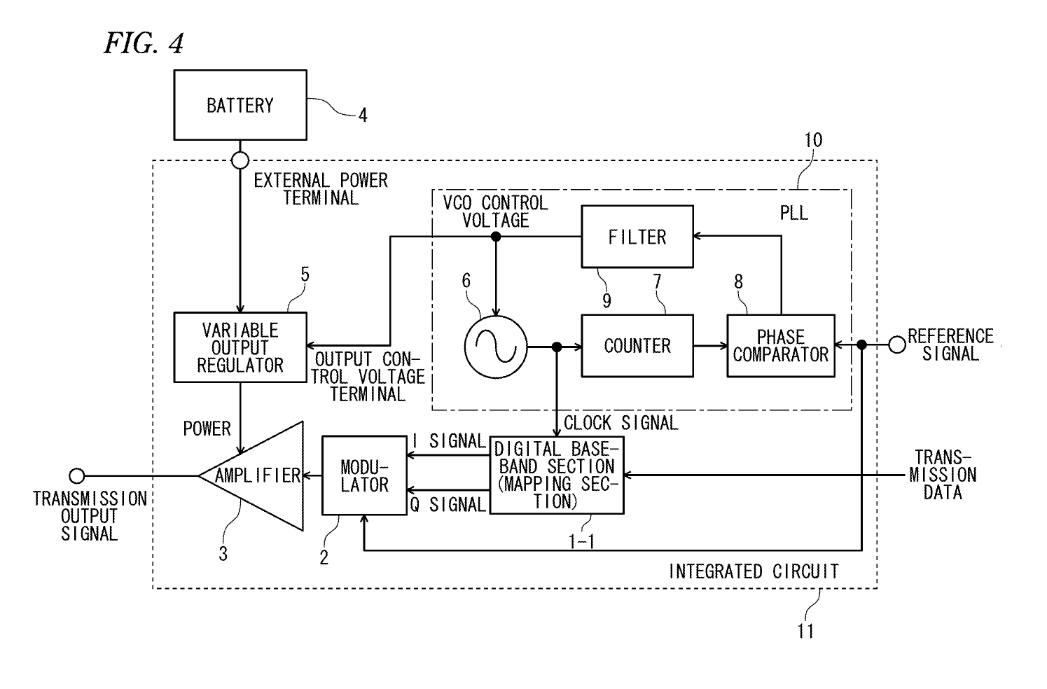

FIG. 4 is a block diagram showing a configuration of a wireless apparatus of a first embodiment of the invention. The first embodiment shows an example of a configuration in which the invention is applied to a transmission circuit of the wireless apparatus.

The wireless apparatus includes a digital baseband section (a mapping section) 1-1, a modulator 2, an amplifier 3, a battery 4, a variable output regulator 5, and a PLL circuit 10. The digital baseband section 1-1, the modulator 2, the amplifier 3, the variable output regulator 5, and the PLL circuit 10 are fabricated in an integrated circuit 11. In particular, at least the amplifier 3 and the PLL circuit 10 are fabricated on the same chip.

The digital baseband section 1-1 operates in response to a clock signal having a predetermined frequency output from the PLL circuit 10, produces as transmission baseband signals an I signal and a Q signal, which are quadrature signals, from transmission data, and outputs the thus-produced transmission baseband signals. In short, the digital baseband section 1-1 maps transmission data at a signal point on an I-Q plane.

The modulator 2 modulates the I signal and the Q signal output from the digital baseband section 1-1, generating a high frequency modulated signal. The amplifier 3 amplifies the high frequency modulated signal output from the modulator 2, outputting a transmission output signal.

The variable output regulator 5 varies a supply voltage of the amplifier 3 according to a VCO control voltage output from the PLL circuit 10. The battery 4 is connected to an input terminal of the variable output regulator 5 by way of an external power terminal, and the input terminal of the variable output regulator 5 is supplied with a voltage output from the battery 4. A power terminal of the amplifier 3 is connected to an output terminal of the variable output regulator 5, and the amplifier 3 is supplied with a variable supply voltage commensurate with the VCO control voltage.

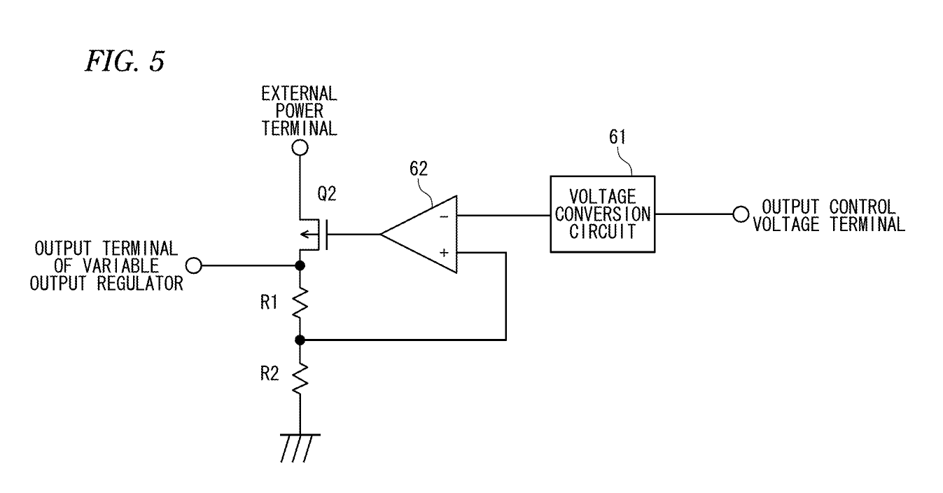

FIG. 5 is a diagram showing a configuration of the variable output regulator 5. The variable output regulator 5 includes a voltage conversion circuit 61, an operational amplifier 62, and a transistor Q2. An input terminal of the voltage conversion circuit 61 is connected to an output control voltage terminal to which the VCO control voltage is input from the PLL circuit 10. An output terminal of the voltage conversion circuit 61 is connected to a negative input terminal of the operational amplifier 62. The voltage conversion circuit 61 is circuitry for converting the VCO control voltage to an input voltage level of the operational amplifier 62.

A gate terminal of the transistor Q2 is connected to an output terminal of the operational amplifier 62, and the voltage output from the battery 4 is supplied to an external power terminal to which a drain terminal of the transistor Q2 is connected. A source terminal of the transistor Q2 is connected to the output terminal, and a voltage output from the variable output regulator 5 is supplied to the power terminal of the amplifier 3 from the output terminal. Further, the source terminal of the transistor Q2 is grounded by way of series-connected resistors R1 and R2, and a node between the resistors R1 and R2 is connected to a positive input terminal of the operational amplifier 62. The voltage output from the variable output regulator 5 is divided into voltages by way of the resistors R1 and R2, and the thus-divided voltages are fed back to the operational amplifier 62.

The PLL circuit 10 includes a voltage controlled oscillator (VCO) 6, a counter 7 for counting an output frequency of the VCO 6, a phase comparator 8 that compares a reference signal with the phase of a signal output from the counter 7 and that outputs an error signal, and a filter 9 that removes an a.c. component of the error signal output from the phase comparator 8. An output of the filter 9 is fed back to the VCO 6 as a VCO control voltage for controlling the output frequency of the VCO 6. Further, the VCO control voltage is input also to the output control voltage terminal of the variable output regulator 5.

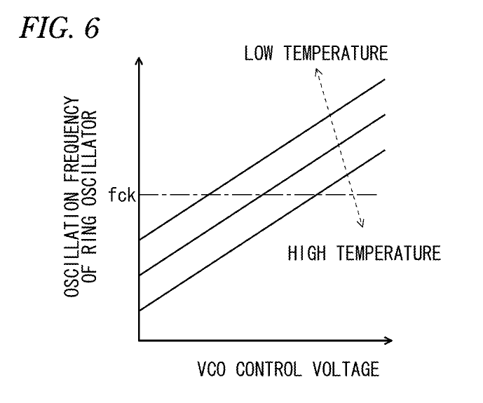

The VCO 6 is made up of a ring oscillator. FIG. 6 is a graph showing an example of temperature dependence of an oscillation frequency of the ring oscillator appearing when the PLL circuit 10 is not locked. In FIG. 6, a horizontal axis represents a VCO control voltage, and a vertical axis represents an oscillation frequency. As shown in FIG. 6, when a temperature falls, a curve of an oscillation frequency-VCO control voltage shifts in a direction in which the frequency becomes higher. When the temperature rises, the curve shifts in a direction in which the frequency becomes lower as opposed to the case of the temperature fall. Reasons for them are that an operation delay time of the inverter that makes up the ring oscillator becomes shorter at a lower temperature and longer at a high temperature. Reference symbol fck denotes a frequency at which the PLL circuit 10 is locked.

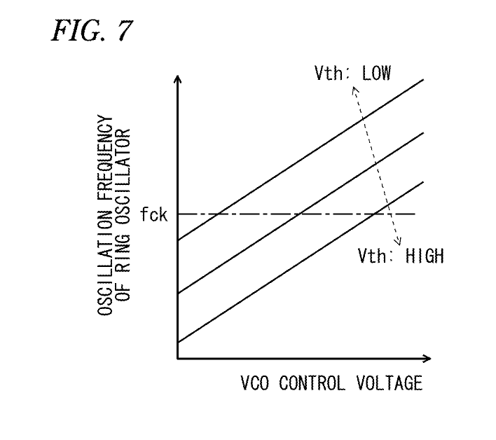

FIG. 7 is a graph showing an example of process variation dependence of the oscillation frequency of the ring oscillator appearing when the PLL circuit 10 is not locked. In FIG. 7, a horizontal axis represents a VCO control voltage, and a vertical axis represents an oscillation frequency. As shown in FIG. 7, when process variations occur in a direction in which a threshold voltage Vth of the transistor in the ring oscillator decreases, the curve of the oscillation frequency-VCO control voltage shifts in a direction in which the frequency becomes higher. When process variations occur in a direction in which a threshold voltage Vth of the transistor in the ring oscillator increases, however, the curve of the oscillation frequency-VCO control voltage shifts in a direction in which the frequency becomes lower. Reasons for them are that the operation delay time of the inverter that makes up the ring oscillator becomes shorter when the threshold voltage Vth of the transistor is low and becomes longer when the threshold voltage Vth of the transistor becomes higher.

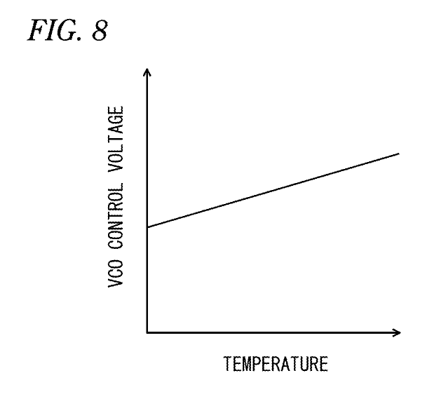

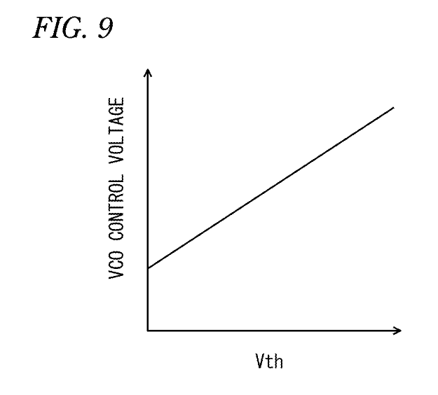

During operation of the wireless apparatus, the PLL circuit 10 is locked, and the output frequency of the VCO 6 is locked to a predetermined frequency fck. As can be seen in FIG. 6, the VCO control voltage acquired during oscillation of the frequency fck varies depending on a temperature. Likewise, as can be seen in FIG. 7, the VCO control voltage acquired during oscillation of the frequency fck varies depending on the threshold voltage Vth of the transistor. FIG. 8 corresponds to FIG. 6, and FIG. 9 corresponds to FIG. 7.

FIG. 8 is a graph showing an example of temperature dependence of the VCO control voltage appearing when the PLL circuit 10 is locked. In FIG. 8, a horizontal axis represents a temperature, and a vertical axis represents a VCO control voltage. FIG. 9 is a graph showing an example of process variation dependence of the VCO control voltage appearing when the PLL circuit 10 is locked. In FIG. 9, a horizontal axis represents the threshold voltage Vth of the transistor, and a vertical axis represents a VCO control voltage. As can be seen in FIGS. 8 and 9, temperature or process variations can be detected by observation of the VCO control voltage.

In the supply voltage regulator of Patent Literature 1, temperature or process variations are detected by observation of an output frequency of the ring oscillator. However, a ring oscillator for detection purpose must be additionally provided.

The embodiment, however, employs a configuration in which the ring oscillator of the PLL circuit 10 that generates a clock signal of the digital baseband section 1-1 is diverted for detection and in which another ring oscillator to serve as a detection circuit is not newly provided. The PLL circuit 10 is locked during operation of the wireless apparatus, and the output frequency is locked. It is, for this reason, difficult to detect temperature or process variations by observation of an output frequency used in the supply voltage regulator described in connection with Patent Literature 1. Accordingly, in the embodiment, the temperature or process variations in the integrated circuit 11 are equivalently detected by observation of the VCO control voltage.

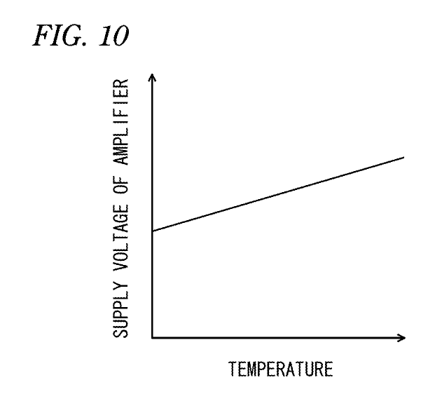

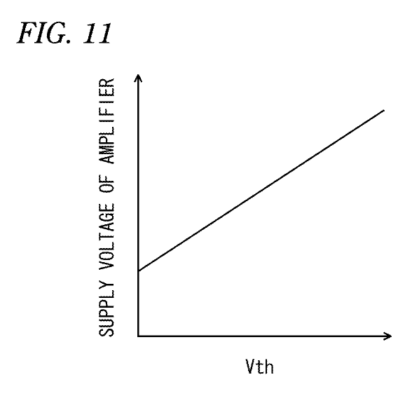

In the embodiment, the VCO control voltage is input to the variable output regulator 5, to thereby change the output voltage of the variable output regulator 5 in accordance with a change in the VCO control voltage. When temperature or process variations occur in the integrated circuit 11, the supply voltage of the amplifier 3 can be controlled in accordance with the temperature or process variations. FIG. 10 is a graph showing an example of amplifier's supply voltage characteristic versus temperature variation, and FIG. 11 is a graph showing an example of amplifier's supply voltage characteristic versus process variation.

As mentioned previously, the frequency characteristic of the amplifier is deteriorated as the temperature rises. However, the supply voltage of the amplifier also increases as shown in FIG. 10 and, therefore, deterioration of the frequency characteristic is compensated for. On the contrary, when the temperature falls, the frequency characteristic of the amplifier is improved, so that power consumption can be diminished by decreasing the supply voltage of the amplifier.

Moreover, the frequency characteristic of the amplifier is deteriorated as the threshold voltage Vth of the transistor increases for reasons of process variations. However, the supply voltage of the amplifier also increases as shown in FIG. 11, deterioration of the frequency characteristic is compensated for. On the contrary, when threshold voltage Vth of the transistor decreases, the frequency characteristic of the amplifier is improved, so that power consumption can be diminished by decreasing the supply voltage of the amplifier.

As above, there can be provided a wireless apparatus capable of optimizing performance even when temperature variations or process variations occur by controlling the supply voltage of the amplifier in accordance with the VCO control voltage of the clock generation PLL circuit in the digital baseband section without addition of separate circuitry specifically designed to detect variations, like a ring oscillator.

In particular, since a frequency of a signal used in a wireless apparatus that performs wireless communication by use of a millimeter wave band is high, a greater effect can be yielded. For instance, in a wireless apparatus using a 60-GHz millimeter wave band, a maximum oscillation frequency fₘₐₓ of a high frequency circuit is of the order of 100 GHz and close to a frequency of the high frequency signal, and hence the maximum oscillation frequency fₘₐₓ greatly affects circuit performance. Accordingly, performance deterioration due to temperature or process variations can be appropriately compensated for by means of controlling the supply voltage of the high frequency circuit in accordance with the VCO control voltage.

The first embodiment adopts a configuration in which the supply voltage of the amplifier is varied by the variable regulator. A target whose performance deterioration is compensated for by controlling a supply voltage in accordance with a VCO control voltage is not limited to an amplifier. Moreover, although the first embodiment shows the example of the configuration of the transmission circuit, the invention is not limited to the transmission circuit.

### Second Embodiment

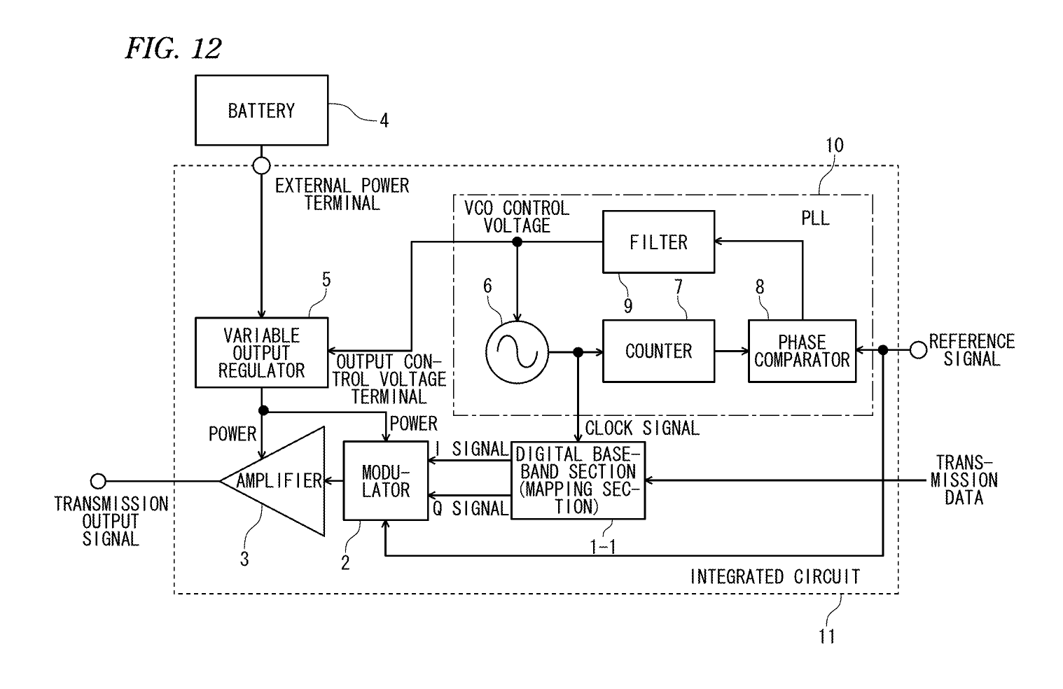

FIG. 12 is a block diagram showing a configuration of a wireless apparatus of a second embodiment of the invention. The second embodiment is a modification of the first embodiment and is directed toward a wireless apparatus that varies the supply voltage of the modulator in accordance with the VCO control voltage as in the case of the amplifier.

The output terminal of the variable output regulator 5 is connected to the power terminal of the amplifier 3 and to a power terminal of the modulator 2. In other respects, the wireless apparatus is analogous in configuration to its counterpart of the first embodiment shown in FIG. 4, and hence its repeated explanation is omitted.

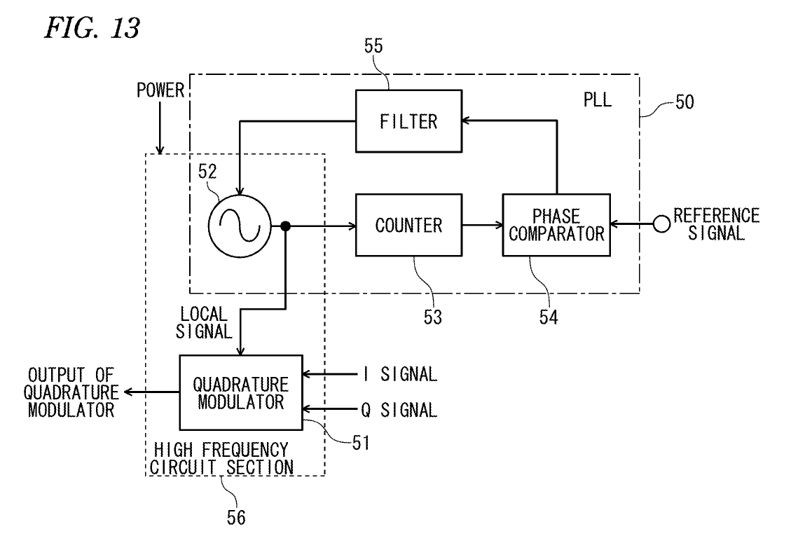

FIG. 13 is a diagram showing a configuration of the modulator 2. The modulator 2 includes a PLL circuit 50 that generates a local signal from a reference signal and a quadrature modulator 51 that modulates an I signal and a Q signal, which are quadrature signals, by means of the local signal. The PLL circuit 50 includes an oscillator 52, a counter 53 that counts an output frequency of the oscillator 52, a phase comparator 54 that compares a phase of the reference signal with a phase of a signal output from the counter 53 and that outputs an error signal, and a filter 55 that removes an a.c. component from the error signal output from the phase comparator 54.

A high frequency circuit section 56 including the quadrature modulator 51 and the oscillator 52 is supplied with, as a supply voltage, an output voltage of the variable output regulator 5.

In the second embodiment, the output voltage of the variable output regulator 5 is varied in accordance with a change in VCO control voltage of the PLL circuit 10, and the output voltage is supplied as a supply voltage to the amplifier 3 and the modulator 2 as in the case of the first embodiment. The VCO control voltage changes in accordance with temperature variations or process variations in the integrated circuit 11, so that the supply voltage of the modulator 2 can be varied in accordance with the VCO control voltage.

As above, there can be provided a wireless apparatus capable of optimizing performance of the modulator even when temperature variations or process variations occur by controlling the supply voltage of the modulator in accordance with the VCO control voltage of the clock generation PLL circuit in the digital baseband section without addition of another circuitry specifically designed to detect variations, such as a ring oscillator. In particular, a frequency of a signal employed in a wireless apparatus that performs wireless communication by use of a millimeter wave band is high, and hence a greater effect can be yielded.

### Third Embodiment

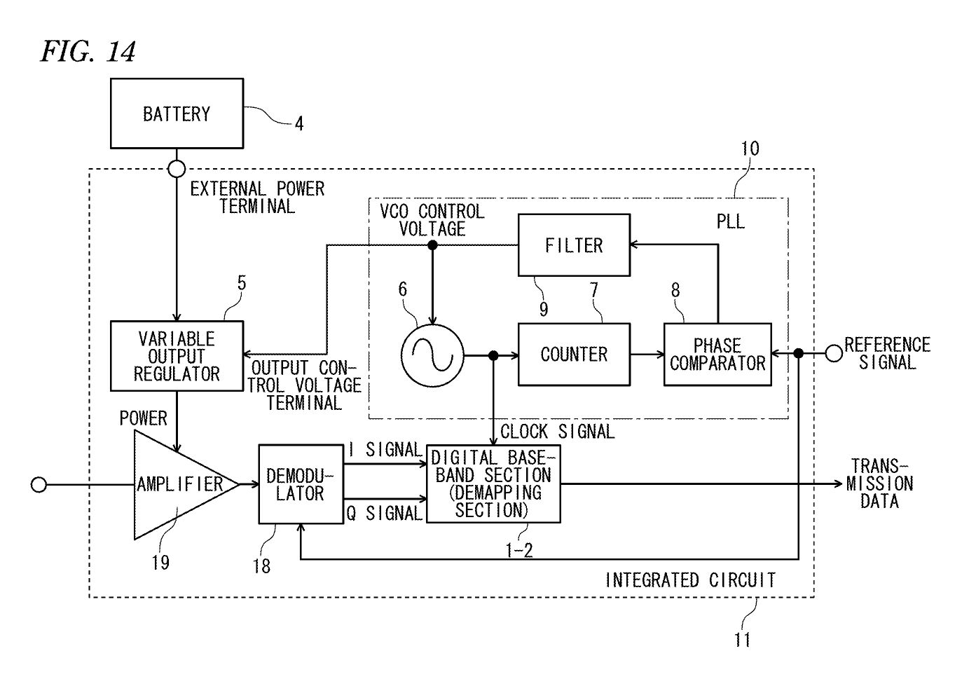

FIG. 14 is a block diagram showing a configuration of a wireless apparatus of a third embodiment of the invention. The third embodiment shows a configuration in which the invention is applied to a receiving circuit of the wireless apparatus.

The wireless apparatus includes a digital baseband section (a demapping section) 1-2, a demodulator 18, an amplifier 19, the battery 4, the variable output regulator 5, and the PLL circuit 10. The digital baseband section 1-2, the demodulator 18, the amplifier 19, the variable output regulator 5, and the PLL circuit 10 are fabricated on the integrated circuit 11. In particular, at least the amplifier 19 and the PLL circuit 10 are fabricated on the same chip.

The amplifier 19 is an amplifier for amplifying a high frequency signal and amplifies a received input signal that is a high frequency modulated signal and outputs the thus-amplified signal to the demodulator 18. The demodulator 18 demodulates the received input signal amplified by the amplifier 19 and outputs an I signal and a Q signal, which are quadrature signals, as received baseband signals.

The digital baseband section 1-2 operates in response to a clock signal that is output from the PLL circuit 10 and that has a predetermined frequency, and acquires received data from the I signal and the Q signal that have been demodulated by the demodulator 18. Specifically, the digital baseband section 1-2 demaps the received data at a signal point mapped on the I-Q plane.

The output terminal of the variable output regulator 5 is connected to a power terminal of the amplifier 19. The PLL circuit 10, the variable output regulator 5, and others, are analogous in configuration to their counterparts described in connection with the first embodiment, and hence their repeated explanations are omitted here for brevity.

In the third embodiment, the output voltage of the variable output regulator 5 is changed in accordance with a change in the VCO control voltage of the PLL circuit 10, and the output voltage is supplied as a supply voltage to the amplifier 19 of the receiving circuit in the same way as in the first embodiment. The VCO control voltage changes in accordance with temperature or process variations in the integrated circuit 11, and the supply voltage of the amplifier 19 is varied in accordance with the VCO control voltage.

As above, there can be provided a wireless apparatus capable of optimizing performance even when temperature variations or process variations occur by controlling the supply voltage of the amplifier of the receiving circuit in accordance with the VCO control voltage of the clock generation PLL circuit in the digital baseband section without addition of separate circuitry specifically designed to detect variations, like a ring oscillator. In particular, since a frequency of a signal used in a wireless apparatus that performs wireless communication by use of a millimeter wave band is high, a greater effect can be yielded.

As in the case of the second embodiment, performance deterioration due to temperature or process variations can be compensated for by means of supplying the output voltage of the variable output regulator 5 even to the high frequency circuit section, or the like, of the demodulator.

Various changes and applications of the present invention may be made by those skilled in the art on the basis of the description of this specification and known techniques without departing from the spirit and scope of the present invention, and these are also included in the range of the request for protection. In addition, the respective components in the embodiments described above may be arbitrarily combined without departing from the scope of the invention.

This application is based on Japanese Patent Application (Japanese Patent Application No. 2011-051894) filed on Mar. 9, 2011, the disclosure of which is incorporated herein by reference in its entirety.

### INDUSTRIAL APPLICABILITY

The invention yields an advantage of the ability to optimize performance even when temperature variations or process variations occur without addition of separate circuitry for detecting variations, like an oscillator for detection purpose, and is useful as a wireless apparatus equipped with a digital baseband section and a high frequency circuit.

### REFERENCE SIGNS LIST

1 DIGITAL BASEBAND SECTION

1-1 DIGITAL BASEBAND SECTION (MAPPING SECTION)

1-2 DIGITAL BASEBAND SECTION (DEMAPPING SECTION)

2 MODULATOR

3 AMPLIFIER

4 BATTERY

5 VARIABLE OUTPUT REGULATOR

6 VOLTAGE CONTROLLED OSCILLATOR (VCO)

7, 53 COUNTER

8, 54 PHASE COMPARATOR

9, 55 FILTER

10 PLL

11 INTEGRATED CIRCUIT

12 REGULATOR

18 DEMODULATOR

19 AMPLIFIER

51 QUADRATURE MODULATOR

52 OSCILLATOR

61 VOLTAGE CONVERSION CIRCUIT

62 OPERATIONAL AMPLIFIER

Q1, Q2 TRANSISTOR

L1 LOAD

1. A wireless apparatus comprising:
a PLL circuit that has a voltage controlled oscillator configured to oscillate a signal having a frequency commensurate with a control voltage;
a variable output regulator configured to change an output voltage in accordance with the control voltage; and
a high frequency circuit that is supplied with, as a supply voltage, the output voltage of the variable output regulator.

2. The wireless apparatus according to claim 1, wherein the PLL circuit and the high frequency circuit are fabricated on a same integrated circuit.

3. The wireless apparatus according to claim 2, wherein the high frequency circuit includes at least any one of an amplifier configured to amplify a high frequency signal, a high frequency circuit section of a modulator, and a high frequency circuit section of a demodulator.
